(19) United States
(12) Patent Application Publication
(10) Pub. No.: US 2004/0209648 A1
(43) Pub. Date: Oct. 21, 2004

(54) Radio transmission memory card, and handset transmission electronic transaction system and method using the same

(75) Inventor: Chien-Yuan Chen, Banchiau City (TW)

Correspondence Address: TROXELL LAW OFFICE PLLC, SUITE 1404, 5205 LEESBURG PIKE, FALLS CHURCH, VA, 22041, US

(73) Assignee: Power Data Communications Co., Ltd.

(21) Appl. No.: 10/419,133

(22) Filed: Apr. 21, 2003

(51) Int. Cl. H04M 1/00

(52) U.S. Cl. 455/558; 455/517; 455/411

(57) ABSTRACT

A radio transmission memory card, and a handset transmission electronic transaction system and method using the same, wherein transaction system includes a handset, a memory card, a user identification card, a mobile base station and a transaction terminal, and between the handset, the memory card, the user identification card, the mobile base station and the transaction terminal is provided with a radio transmission circuit structure. When a handset holder proceeds a transactions at the transaction terminal, a transaction message and a confirmation message are sent by both sides, the transaction terminal and the mobile base station respectively; the transaction terminal delivers a purchased product upon receiving the confirmation message and sends a message of completed transaction upon delivery of the product; and the mobile base station sends a message to inform a payment terminal to charge the transaction amount using another radio transmission circuit structure.

### BACKGROUND OF THE INVENTION

(a) Field of the Invention

The invention relates to a radio transmission memory card, and a radio transmission electronic transaction system and method using the same, and more particularly, to a transaction system comprising a handset, a memory card, a user identification card and a mobile base station, so as to have the user identification card function as readily portable plastic money, as well as to significantly reduce transaction time by exchanging transactions messages through a radio transmission circuit structure.

(b) Description of the Prior Art

Accompanied with evolvement of the modern times, plastic money has gradually reached maturity and is widely accepted throughout the world, and the most extensively used plastic money at the moment is credit card, by which the cardholder completes purchase transactions. Not only troubles caused by dealing with cash in conventional transactions are solved, but the card itself also represents personal credit of the cardholder. However, certain loopholes are also brought about in the plastic monetary transaction system as technologies advance. Of all problems, forging and misappropriation are the most serious for that it is mandatory to hand a credit card over to a clerk for a transaction process, and thus a leak is incurred. The credit card may be replicated with negligence of a split second, and substantial losses of the cardholder and the finance corporation are subsequently caused.

In addition, credit card systems are considered as rather huge investments. For example, stores have to own credit card machines that are manually operated; for credit card machines that are not constantly in connection, stores are obligated to call respective card issue organizations for acquiring authorization numbers; for credit card machines that are connected, swiping of credits card are often repeated due to connection problems, and thus time is still required for connection as well as likely inflicting repeated charging. Furthermore, credit card systems are limited to certain transactions; for instance, credit cards cannot be used for vending machines seen all over because of equipment and manpower cost for credit card systems.

### SUMMARY OF THE INVENTION

Therefore, in the view of the aforesaid shortcomings, the object of the invention is to provide a radio transmission memory card, and handset transmission electronic transaction system and method using the same, wherein the transaction system comprises a handset, a user identification card and a mobile base station, so as to have the user identification card function as readily portable plastic money, as well as to significantly reduce transaction time by exchanging transactions messages through a radio transmission circuit structure.

### BRIEF DESCRIPTION OF THE DRAWINGS

FIG. 1 shows a structural schematic view illustrating an embodiment of the handset according to the invention.

FIG. 2 shows a block schematic diagram illustrating the circuit of the memory card according to the invention.

FIG. 3 shows a structural schematic view illustrating a preferred embodiment of the handset according to the invention.

FIG. 4 shows a flow chart of the transaction method according to the invention.

### DETAILED DESCRIPTION OF THE PREFERRED EMBODIMENTS

To better understand the characteristics, object and functions of the invention, descriptions shall be given with the accompanying drawings hereunder.

In accordance with the invention, the radio transmission memory card, and the radio transmission electronic transaction system and method using the same, the system comprises a handset, a user identification card (commonly referred to as subscriber identity module, SIM), a mobile base station, and a transaction terminal. Between the handset, the user identification card, the mobile base station and the transaction terminal is provided with a radio transmission circuit structure, and between the mobile base station and a payment terminal is further provided with another radio transmission circuit structure.

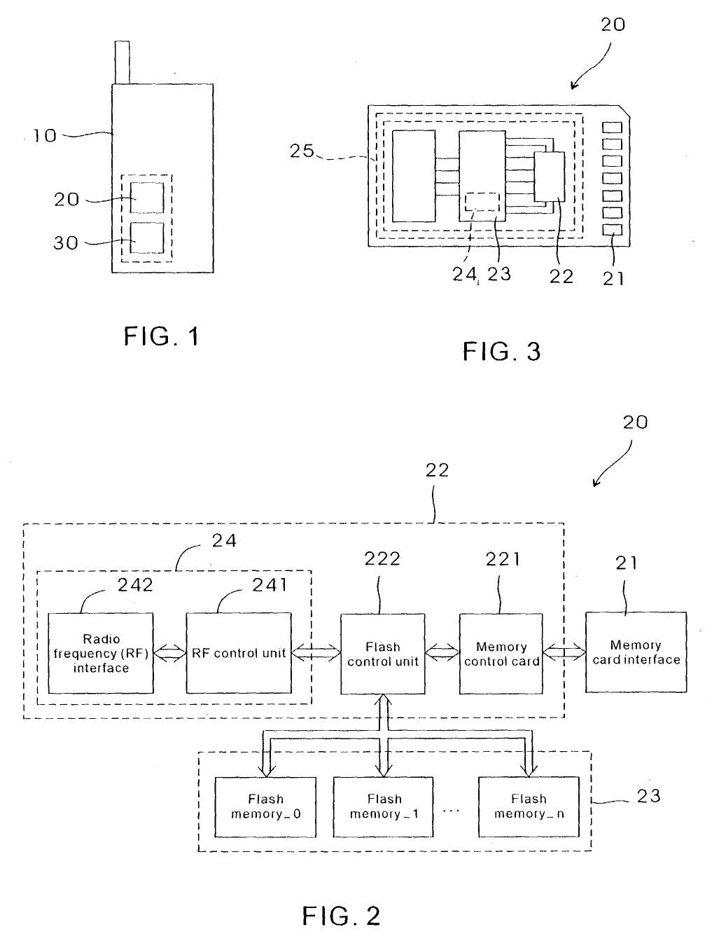

Referring to FIGS. 1 to 3 showing an embodiment of the invention, a handset 10 comprises a memory card 20 and a user identification card 30. Wherein, the memory card 20 is a flash memory card having a memory card interface 21, a controller chip 22 and at least one memory chip 23. The aforesaid controller chip 22 comprises a memory card controller 221, a flash controller unit 222, and a radio control circuit 24 having a radio frequency (RF) controller unit 241 and an RF interface 242. At the periphery of the memory card 20 is disposed with an antenna 25, and a handset battery is placed with a radio control circuit (not shown in the diagram) for exchanging messages with the aforesaid radio control circuit 24, thus completing a payment system with the user identification card of the handset.

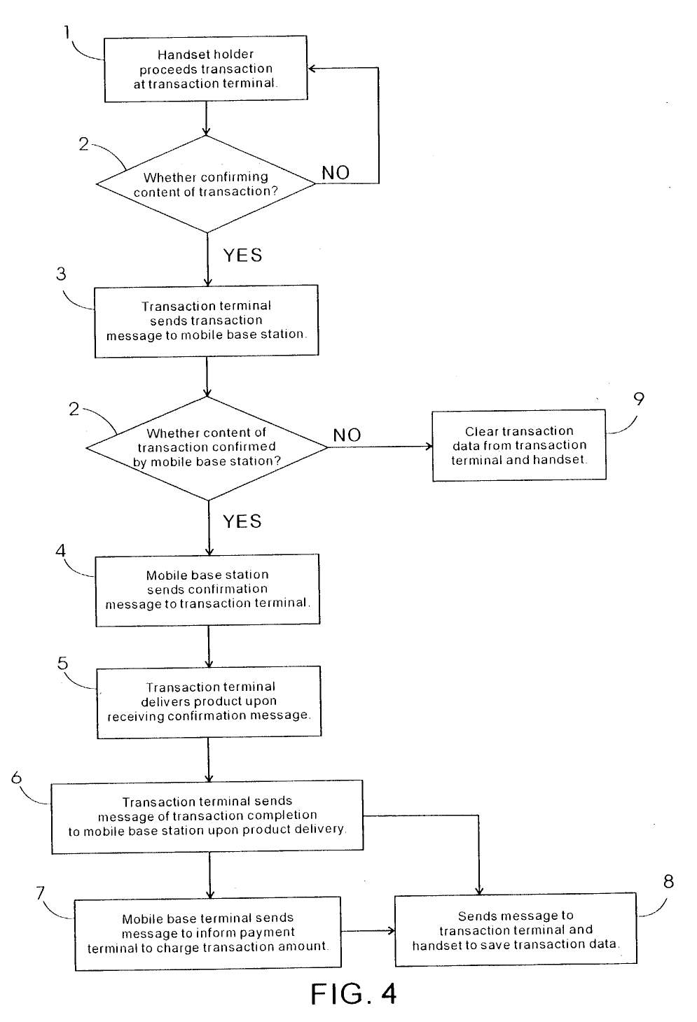

Referring to FIG. 4, the transaction method according to the invention comprises the steps of:

A. proceeding a transaction by a handset holder at the transaction terminal (1), confirming item name, quantity and amount by the transaction terminal (2), sending a transaction message to the mobile base station by the transaction terminal (3);

B. sending a confirmation message to the transaction terminal after confirming the transaction content by the mobile base station (4), or sending a message of incomplete transaction to the handset and the transaction terminal by the mobile base station for failures of confirming transaction content by the mobile base station to terminate the transaction, and clearing the transaction data in the handset and at the transaction terminal (9), and printing a transaction termination record by the transaction terminal;

C. delivering a purchased product upon receiving the confirmation message by the transaction terminal. (5), and printing a delivery record upon delivery of the product by the transaction terminal;

D. sending a message of completed transaction to the mobile base station by the transaction terminal upon delivery of the product (6); and

E. sending a message by the mobile base station to inform the payment terminal to charge the transaction amount (7), wherein the payment terminal may be a bank, or may be provided at the mobile base station for directly charging therein; sending a message of charge to the handset holder and the transaction terminal by the mobile base station to save the transaction data, and printing a payment receipt upon receiving the message of completed charge by the transaction terminal.

Conclusive from the above, the transaction system according to the invention comprises a handset, a user identification card, and a mobile base station, wherein the user identification card functions as readily portable plastic money, and the transaction time thereof is significantly reduced by exchanging transactions messages through a radio transmission circuit structure. It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A radio transmission memory card for a handset transmission electronic transaction system and method, as a flash memory card comprising a memory card interface, a controller chip and at least one memory chip, and an antenna disposed at an appropriate location of the memory card, wherein the controller chip further comprising a memory card controller, a flash controller unit, and a radio control circuit having and a radio frequency (RF) controller unit and an RF interface.

2. A handset transmission electronic transaction system comprising:
a handset;
a memory card disposed in the handset;
a user identification card disposed in the handset;
a mobile base station;
a transaction terminal providing products required by consumers; and
a radio transmission circuit structure provided between the handset, the memory card, the user identification card, the mobile base station, and the transaction terminal; wherein when a handset holder proceeds a transaction at the transaction terminal, the transaction terminal sends a transaction message to the mobile base station, the mobile base station sends a confirmation message to the transaction terminal upon confirmation of the transaction content, the transaction terminal delivers a product purchased upon receiving the confirmation message, and the transaction terminal sends a message of completed transaction to the mobile base station upon delivery of the product.

3. The handset transmission electronic transaction electronic system in accordance with claim 2, wherein the memory card is a flash memory card having a memory interface, a controller chip and at least a memory chip, and an antenna is disposed at an appropriate location of the memory card; wherein the controller chip further comprising a memory card controller, a flash controller unit, and a radio control circuit having and an RF controller unit and an RF interface.

4. The handset transmission electronic transaction system in accordance with claim 2, wherein between the mobile base station and a payment terminal is further provided with another radio transmission circuit structure, such that after the transaction terminal sends a message of completed transaction to the mobile base station, the mobile base station sends a message to inform the payment terminal to charge the transaction amount.

5. The handset transmission electronic transaction system in accordance with claim 2, wherein the radio transmission circuit structure is disposed in a handset battery.

6. The handset transmission electronic transaction system in accordance with claim 2, wherein the radio transmission circuit structure of the handset is a short-distance radio transmission circuit structure.

7. The handset transmission electronic transaction system in accordance with claim 2, wherein the user identification card is a flash memory card having a controller chip provided with a radio transmission control circuit and an antenna.

8. A handset transmission electronic transaction method comprising the steps of:
A. forming a transaction system using a handset, a memory car, a user identification card, a mobile base station and a transaction terminal, wherein between the handset, the memory card, the user identification card, the mobile base station and the transaction terminal is provided with a radio transmission circuit structure;
B. sending a transaction message to the mobile base station by the transaction terminal when processing a transaction by the handset holder at the transaction terminal;
C. sending a confirmation message to the transaction terminal upon confirmation of the transaction content by the mobile base station;
D. delivering a purchased product upon receiving the confirmation message by the transaction terminal; and
E. sending a message of completed transaction to the mobile base station by the transaction terminal upon delivery of the product.

9. The handset transmission electronic transaction system in accordance with claim 8, wherein between the mobile base station and a payment terminal is further provided with another radio transmission circuit structure, such that after the transaction terminal sends a message of completed transaction to the mobile base station, the mobile base station sends a message to inform the payment terminal to charge the transaction amount.

10. The handset transmission electronic transaction system in accordance with claim 9, wherein the payment terminal sends a message of charge to the mobile base station after the mobile base station sends a message to inform the payment terminal to charge the transaction amount, and then the mobile base station sends the message of charge to the handset holder and the transaction terminal.

11. The handset transmission electronic transaction system in accordance with claim 8, wherein the user identification card is a flash memory card having a controller chip provided with a radio control circuit and an antenna.

12. The handset transmission electronic transaction system in accordance with claim 8, wherein the radio transmission circuit structure is disposed in a handset battery.

13. The handset transmission electronic transaction system in accordance with claim 8, wherein the radio transmission circuit structure of the handset is a short-distance radio transmission circuit structure.

14. The handset transmission electronic transaction system in accordance with claim 8, wherein when the mobile base station fails to confirm the transaction content, the mobile base station sends a message of incomplete transaction to the handset and the transaction terminal to terminate the transaction, and clears transaction data in the handset and the transaction terminal.

15. The handset transmission electronic transaction system in accordance with claim 8, wherein the memory card is a flash memory card having a memory interface, a controller chip and at least a memory chip, and an antenna disposed at an appropriate location of the memory card; wherein the controller chip further comprising a memory card controller, a flash controller unit, and a radio control circuit having and an RF controller unit and an RF interface.
